(19) United States
(12) Patent Application Publication
(10) Pub. No.: US 2010/0177034 A1
(43) Pub. Date: Jul. 15, 2010

(54) PORTABLE STORAGE DEVICE HAVING USER INTERFACE AND METHOD OF CONTROLLING THE USER INTERFACE

(75) Inventors: Seong-hun JEONG, Suwon-si (KR); Hong-seok PARK, Ansan-si (KR); Hee-soo LEE, Hwaseong-si (KR); Houng-sog MIN, Ansan-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/557,871

(22) Filed: Sep. 11, 2009

(30) Foreign Application Priority Data
Jan. 12, 2009 (KR) 10-2009-0002382

(51) Int. Cl. G09G 5/00

(52) U.S. Cl. 345/156

(57) ABSTRACT

A portable storage device and a method of controlling a user interface (UI) using the same. The method includes obtaining first UI information using a UI when the portable storage device is connected to a host, transmitting the obtained first UI information to an application of the host, and displaying second UI information provided by the application of the host using the UI.

### CROSS-REFERENCE TO RELATED PATENT APPLICATION

This application claims priority from Korean Patent Application No. 10-2009-0002382, filed on Jan. 12, 2009, in the Korean Intellectual Property Office, the disclosure of which is incorporated herein in its entirety by reference.

### BACKGROUND OF THE INVENTION

1. Field of the Invention

Apparatuses and methods consistent with the present invention relate to a portable storage device, and more particularly, to a portable storage device having a simple, external user interface (UI) capable of receiving/transmitting data from/to a host and a method of controlling the UI.

2. Description of the Related Art

In general, portable storage devices may store various digital data, such as still picture data, moving picture data, and speech data using a NAND-type flash memory. Also, the portable storage devices are being applied to content reproduction devices, such as MP3 players and portable multimedia players (PMPs).

When a portable storage device is connected to a host, such as a personal computer (PC) or television (TV), a user may input a command using an input device of the host.

Accordingly, the connection of the portable storage device to the host may inconvenience the user by requiring the user to directly input operational commands using a mouse or keyboard of the host.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a portable storage device having a simple, external user interface (UI), which is frequently used in applications and capable of receiving/transmitting UI information from/to a host, and a method of controlling the UI.

According to an aspect of the present invention, there is provided a method of controlling a UI using a storage device. The method includes: obtaining UI information using a predetermined UI when the storage device is connected to a host; transmitting the obtained UI information to an application of the host; and displaying UI information provided by the application of the connected host using the predetermined UI.

According to another aspect of the present invention, there is provided a method of controlling a UI using a storage device. The method includes: obtaining UI information using a predetermined type of UI; changing an operational mode based on the obtained UI information and transmitting the changed operational mode to a host; and displaying the changed operational mode on the predetermined type of UI.

According to another aspect of the present invention, there is provided a storage device including: a UI input unit configured to input user selection information through a UI; a UI output unit configured to display UI information provided from an application of a host through the UI; and a UI control unit configured to encode the user selection information input by UI input unit, decode the UI information provided by the application of the host, and output the encoded and decoded UI information to the UI output unit.

According to another aspect of the present invention, there is provided a host including: an application unit configured to execute an application by selection of a portable storage device; and a UI processing unit configured to drive a UI based on UI information input by the portable storage device and output UI information provided by the application unit.

### BRIEF DESCRIPTION OF THE DRAWINGS

The above and other aspects of the present invention will become more apparent by describing in detail exemplary embodiments thereof with reference to the attached drawings in which:

FIGS. 1A and 1B are exterior views of portable storage devices having a user interface (UI), according to an exemplary embodiment of the present invention;

FIG. 2 is a block diagram of a system in which a portable storage device and a host receive/transmit UI information from/to each other, according to an exemplary embodiment of the present invention;

FIG. 3A is a block diagram of the portable storage device shown in FIG. 2, according to an exemplary embodiment of the present invention;

FIG. 3B is a block diagram of the portable storage device shown in FIG. 2, according to another exemplary embodiment of the present invention;

FIG. 4 is a block diagram of the host shown in FIG. 2, according to an exemplary embodiment of the present invention;

FIG. 5 is a flowchart of a connection setting method for communicating UI information between the host and the portable storage device, according to an exemplary embodiment of the present invention;

FIG. 6 is a flowchart of a method of controlling a UI, according to an exemplary embodiment of the present invention;

FIG. 7 is a flowchart of a method of controlling a UI, according to another exemplary embodiment of the present invention; and

FIG. 8 is a flowchart of a method of controlling a UI, according to another exemplary embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures. Redundant description to different embodiments may be omitted as necessary.

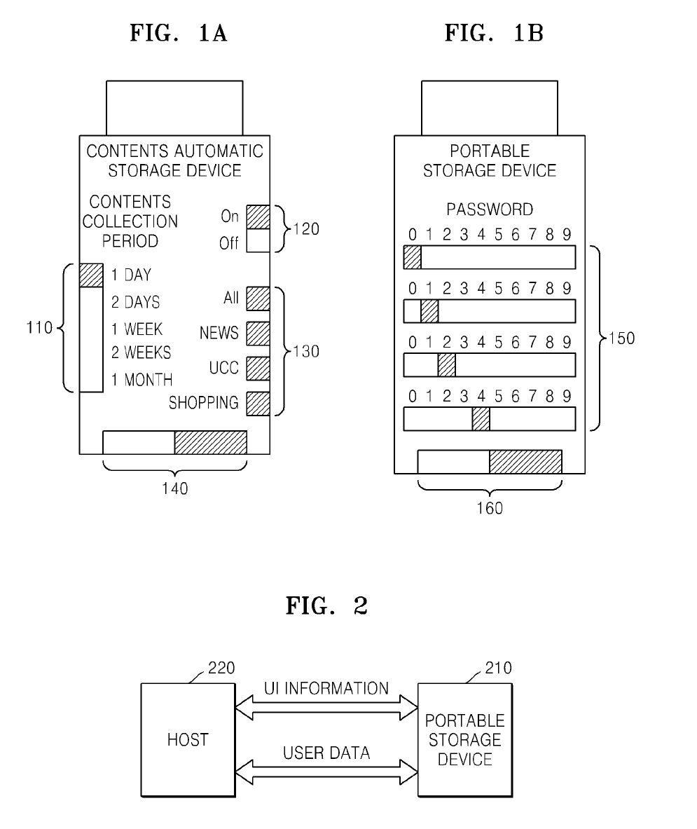

FIGS. 1A and 1B are exterior views of portable storage devices having a user interface (UI), according to an exemplary embodiment of the present invention.

The portable storage device may include a simple UI required to download contents from a host or confirm a password.

Referring to FIGS. 1A and 1B, an additional toggle switch or selection switch for inputting information may be installed outside the portable storage devices.

For example, as shown in FIG. 1A, the portable storage device for automatically storing contents may include a contents collection period selection switch 110, a contents automatic storage on/off switch 120, and a contents type toggle switch 130. Also, as shown in FIG. 1B, the portable storage device may include password input switches 150 for inputting a password.

As shown in FIGS. 1A and 1B, a plurality of light emitting diodes (LEDs) of different colors may be installed outside the portable storage devices in order to display the present operational state of the portable storage devices.

For example, as shown in FIG. 1A, the portable storage device may include an LED 140 capable of indicating an operation and completion of an operation or an LED 160 capable of indicating whether or not the portable storage device is usable.

FIG. 2 is a block diagram of a system in which a portable storage device 210 and a host 220 receive/transmit UI information from/to each other, according to an exemplary embodiment of the present invention.

The system may include the portable storage device 210 and the host 220.

The portable storage device 210 and the host 220 may receive/transmit data by sharing the same interface (e.g., universal serial bus (USB)) or using different interfaces.

User interface information and user data may be communicated between the portable storage device 210 and the host 220 through different channels.

The host 220 may be a personal computer (PC) or a television (TV) using an interface standard, such as a USB.

When the portable storage device 210 is connected to the host 220, the portable storage device 210 may transmit UI information through a simple UI to an application of the host 220 and output UI information of the application, which is received from the host 220, to the simple UI.

When the portable storage device 210 is connected to the host 220, the host 220 may automatically execute the corresponding application of the host 220, transmit the UI information, which is received through the UI of the portable storage device 210, to the application of the host 220, and transmit the UI information, which is received from the executed application of the host 220, to the portable storage device 210.

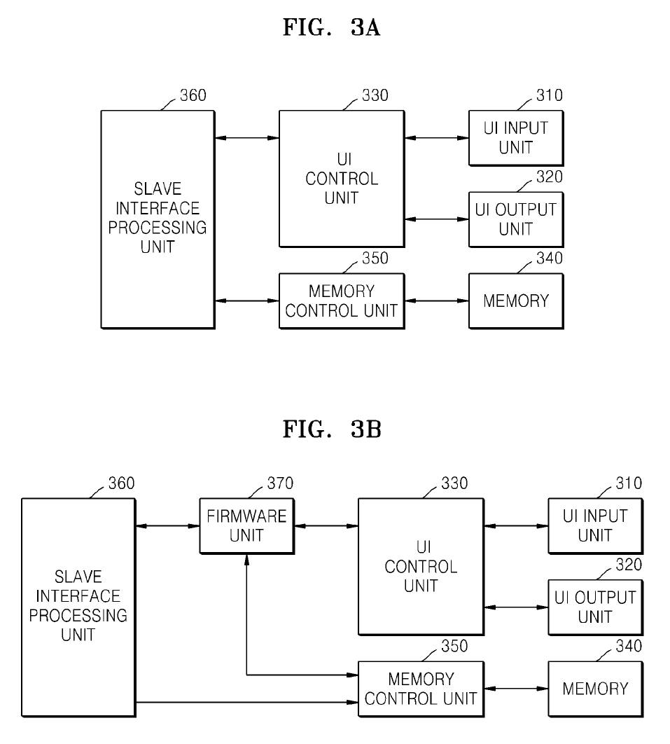

FIG. 3A is a block diagram of the portable storage device 210 of FIG. 2, according to an exemplary embodiment of the present invention.

The portable storage device 210 may include a UI input unit 310, a UI output unit 320, a UI control unit 330, a memory 340, a memory control unit 350, and a slave interface processing unit 360.

The UI input unit 310 may input UI information through a simple UI comprised of toggle switches or selection switches.

The UI output unit 320 may display UI information, which is provided from an application of the host 220, using a UI comprised of a plurality of LEDs of different colors. For example, the UI output unit 320 may display the present operational state of the application of the host 220 using an LED.

The UI control unit 330 may encode the UI information, which is input by the UI input unit 310, decode the UI information of the host 220, which is received through the slave interface processing unit 360, and output the decoded UI information to the UI output unit 320.

The memory 340 may store various contents corresponding to user data via the control of the memory control unit 350. In this case, the user data may be stored as a type of packet that is compressed into a predetermined compressed format.

The memory control unit 350 may store the user data, which is received through the slave interface processing unit 360, in the memory 340.

The slave interface processing unit 360 may establish a data transmission protocol for communicating the UI information and the user data between the portable storage device 210 and the host 220.

FIG. 3B is a block diagram of the portable storage device 210 of FIG. 2, according to another exemplary embodiment of the present invention.

Referring to FIG. 3B, the portable storage device 210 may further include a firmware unit 370, compared with the portable storage device 210 shown in FIG. 3A.

The firmware unit 370 may change an operational mode (e.g., storage mode or signal reproduction mode) of the portable storage device 210 based on the UI information input by the UI input unit 310 or recognize password information input by the UI input unit 310 and generate UI information containing the present operational mode state or operation/stoppage state of the portable storage device 210 based on the changed operational mode or the recognized password information.

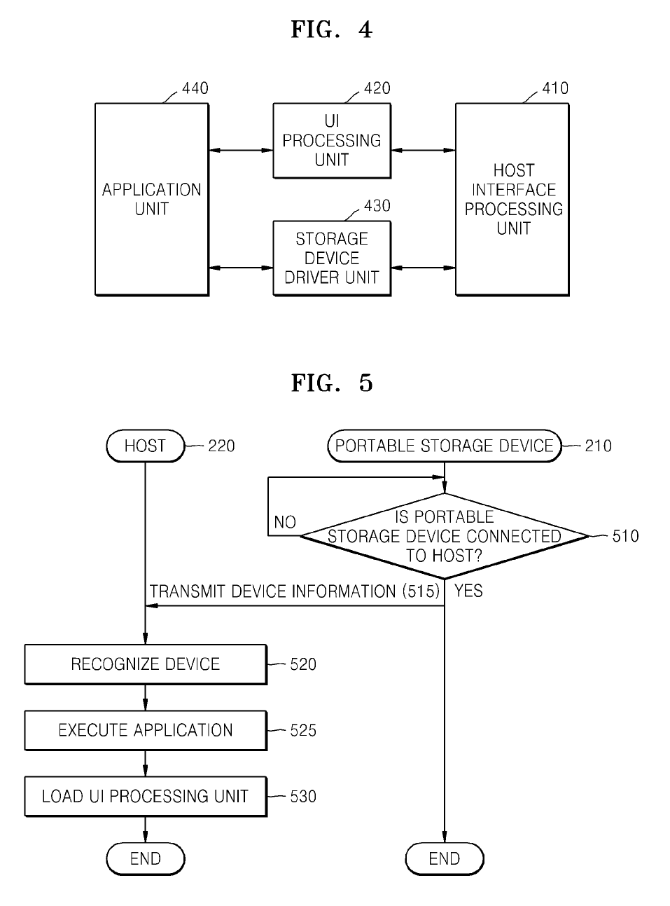

FIG. 4 is a block diagram of the host 220 of FIG. 2, according to an exemplary embodiment of the present invention.

Referring to FIG. 4, the host 220 may include a host interface processing unit 410, a UI processing unit 420, a storage device driver unit 430, and an application unit 440.

The host interface processing unit 410 may establish a data transmission protocol for communicating UI information and user data between the portable storage device 210 and the host 220.

The UI processing unit 420 may drive the UI based on UI information input by the host interface processing unit 410 and UI information transmitted from the application unit 440.

The storage device driver unit 430 may drive the portable storage device 210.

The application unit 440 may store a plurality of application programs. When the portable storage device 210 is connected to the host 220, an application selected by a user may be automatically or manually executed.

FIG. 5 is a flowchart of a connection setting method for communicating UI information between the host 220 and the portable storage device 210, according to an exemplary embodiment of the present invention.

Referring to FIG. 5, the portable storage device 210 may detect whether the portable storage device 210 is connected to the host 220, in operation 510.

In operation 515, if the portable storage device 210 is connected to the host 220, the portable storage device 210 may transmit device information to the host 220.

In operation 520, the host 220 may perform a device recognition process based on the device information received from the portable storage device 210.

In operation 525, the host 220 may automatically or manually execute an application set by the portable storage device 210.

In operation 530, the host 220 may load the UI processing unit 420 and the storage device driver unit 430 to drive the UI.

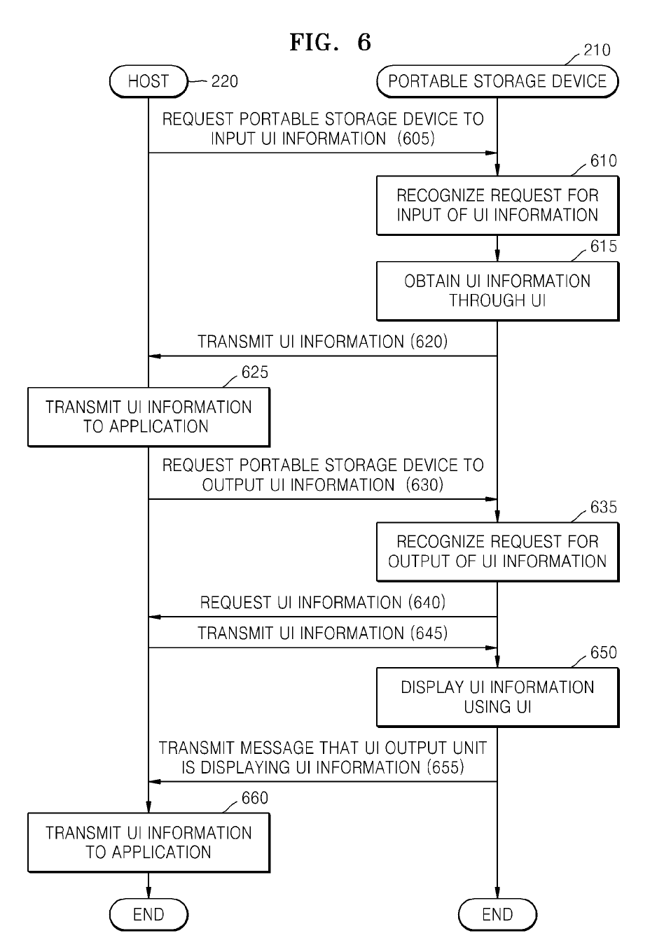

FIG. 6 is a flowchart of a method of controlling a UI, according to an exemplary embodiment of the present invention.

When the portable storage device 210 is connected to the host 220, the host 220 may request the portable storage device 210 to input the UI information, in operation 605.

In operation 610, the portable storage device 210 may recognize the request for the input of the UI information.

In operation 615, the portable storage device 210 may obtain the UI information through the UI.

That is, the portable storage device 210 may obtain the UI information from at least one external data input apparatus.

For example, as shown in FIG. 1A, the contents automatic storage on/off switch 120 may be switched on, the contents type toggle switch 130 may be set as “news” and “UCC”, and the contents collection period selection switch 110 may be set as “1 week”.

In operation 620, the portable storage device 210 may change the obtained UI information into a predetermined interface format and transmit the interface format to the host 220.

Thereafter, the host 220 may transmit the UI information to the executed application of the host 220, in operation 625. In this case, the application of the host 220 may carry out an operation based on the UI information received from the portable storage device 210.

For example, the application of the host 220 may automatically update contents according to a contents collection period and contents type, which are set by the UI of the portable storage device 210.

Meanwhile, the host 220 may request the portable storage device 210 to output the UI information provided by the application of the host 220, in operation 630.

In operation 635, the portable storage device 210 may recognize the request for the output of the UI information.

In operation 640, the portable storage device 210 may request the UI information of the executed application from the host 220.

In operation 645, the host 220 may transmit the contents and UI information from the application to the portable storage device 210. For example, the host 220 may transmit UI information indicating the execution and completion of a contents automatic collection operation to the portable storage device 210.

In operation 650, the portable storage device 210 may display the UI information, which is provided from the application of the host 220, using the UI. That is, the portable storage device 210 may display the operational status, which is provided from the application of the host 220, using a simple UI.

For instance, as shown in FIG. 1A, the portable storage device 210 may drive the LED 140 capable of displaying and completing the operation based on the UI information indicating the execution and completion of the contents automatic collection operation received from the host 220.

Thereafter, in operation 655, the portable storage device 210 may transmit to the host 220 a message that the UI output unit 320 is displaying the UI information.

In operation 660, the host 220 may transmit the UI information of the portable storage device 210 to the executed application.

As a result, a simple UI, which is frequently usable in the application, may be received in the portable storage device 210 so that a user may simply input a desired operation to the portable storage device 210 without inputting information to the host 220 using a mouse or keyboard.

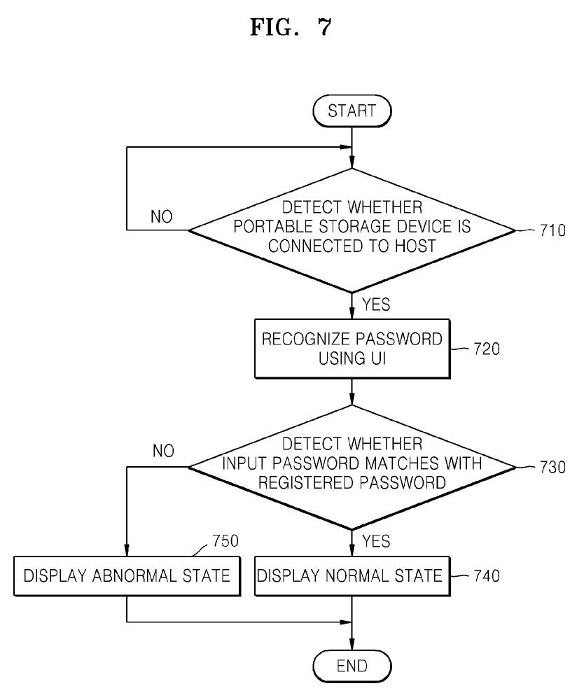

FIG. 7 is a flowchart of a method of controlling a user interface, according to another exemplary embodiment of the present invention.

Initially, it may be detected whether the portable storage device 210 is connected to the host 220, in operation 710.

If the portable storage device 210 is connected to the host 220, the portable storage device 210 may recognize a password input using a UI, in operation 720.

In operation 730, it may be detected whether the password input by a user matches with an already registered password.

In operation 740, if the password input by the user matches with the already registered password, a normal state may be displayed using the UI. In this case, the host 220 and the portable storage device 210 may receive/transmit interface information from/to each other.

However, in operation 750, if the password input by the user does not match with the already registered password, an abnormal state may be displayed using the UI.

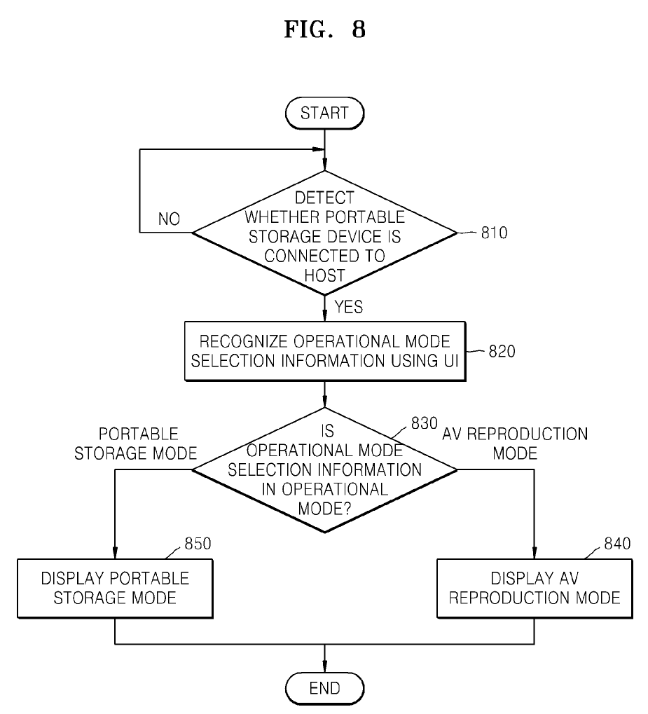

FIG. 8 is a flowchart of a method of controlling a user interface, according to another exemplary embodiment of the present invention.

Initially, it may be detected whether the portable storage device 210 is connected to the host 220, in operation 810.

In this case, if the portable storage device 210 is connected to the host 220, the portable storage device 210 may recognize operational mode selection information using the UI, in operation 820.

In operation 830, it may be determined if the operational mode selection information is a portable storage mode or an audio-visual (AV) reproduction mode.

Thereafter, an operation type may be changed based on the operational mode selection information in operation 840. At this point, information regarding the changed operation type is transmitted to the host 220.

Specifically, if the operational mode selection information is in the portable storage mode, an LED capable of displaying the portable storage mode may be driven in operation 850. In this case, the host 220 may recognize the connected portable storage device 210 as a storage device. Otherwise, if the operational mode selection information is in the AV reproduction mode, an LED capable of displaying the AV reproduction mode may be driven in operation 840. In this case, the host 220 may recognize the connected portable storage device as an AV player. The AV player refers to an virtual application that decodes AV contents stored in the portable storage device 210 into raw data.

Subsequently, the host 220 may drive a driver according to the operation type and execute the application.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard disks, floppy disks, flash memory, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a user interface (UI) using a portable storage device, the method comprising:
obtaining first UI information using a UI when the portable storage device is connected to a host;
transmitting the obtained first UI information to an application of the host; and
displaying second UI information provided by the application of the host using the UI.

2. The method of claim 1, wherein the obtaining the first UI information comprises recognizing the first UI information input through the UI when the portable storage device is requested to input the first UI information by the host.

3. The method of claim 1, wherein the obtaining the first UI information is performed using at least one data input apparatus installed outside the portable storage device.

4. The method of claim 1, wherein the transmitting the obtained first UI information to the application of the host comprises changing the obtained first UI information into an interface format and transmitting the interface format to the host.

5. The method of claim 1, wherein the displaying the second UI information comprises displaying the second UI information provided by the application of the host, using the UI if the portable storage device is requested to output the second UI information by the host.

6. The method of claim 1, wherein the displaying the second UI information comprises displaying operational status information, which is received from the application of the host, using the UI.

7. The method of claim 1, wherein the displaying the second UI information comprises:
installing at least one display device outside the portable storage device; and
displaying the second UI information on the at least one display device.

8. The method of claim 1, wherein the first UI information and the second UI information are input and output through a first channel, and user data is input and output through a second channel.

9. A method of controlling a user interface (UI) using a portable storage device, the method comprising:
obtaining UI information using a UI;
changing an operational mode based on the obtained UI information and transmitting the changed operational mode to a host; and
displaying the changed operational mode on the UI.

10. A method of controlling a user interface (UI) using a host, the method comprising:
executing an application of the host corresponding to a portable storage device and obtaining first UI information from the portable storage device when the portable storage device is connected to the host; and
transmitting the obtained first UI information to the application of the host and outputting second UI information provided by the application of the host to the portable storage device.

11. The method of claim 10, wherein the outputting the second UI information to the portable storage device comprises:
requesting the portable storage device to output the second UI information; and
transmitting the second UI information to the portable storage device when the second UI information is requested by the portable storage device.

12. A portable storage device comprising:
a user interface (UI) input unit which inputs user selection information through a UI;
a UI output unit which displays UI information provided from an application of a host through the UI; and
a UI control unit which encodes the user selection information input by the UI input unit, decodes the UI information provided by the application of the host, and outputs the decoded UI information to the UI output unit.

13. The portable storage device of claim 12, further comprising a firmware unit which changes an operational mode based on the user selection information input by the UI input unit, or recognizes a password input by the UI input unit, and generates the UI information containing a current operational mode or an operation/stoppage state based on the current operational mode or the password.

14. The portable storage device of claim 12, wherein the UI input unit includes a plurality of input apparatuses provided outside the portable storage device.

15. The portable storage device of claim 11, wherein the UI output unit comprises at least one display device disposed outside the portable storage device.

16. A host comprising:
an application unit which executes an application by a selection of a portable storage device; and
a user interface (UI) processing unit which drives a UI based on first UI information input by the portable storage device and outputs second UI information provided by the application unit.

17. A computer-readable medium having embodied thereon a computer program for executing a method of controlling a user interface (UI) using a portable storage device, the method comprising:
obtaining first UI information using a UI when the portable storage device is connected to a host;
transmitting the obtained first UI information to an application of the host; and
displaying second UI information provided by the application of the host using the UI.

18. A method of controlling a user interface (UI) using a portable storage device, the method comprising:
obtaining an input from a user;
transmitting the input from the user to a host device;
receiving UI information from the host device; and
outputting the UI information received from the host device.

19. The method of claim 18, wherein:
the obtaining the input and the transmitting the input are performed in response to a request for user input received from the host device; and
the receiving the UI information and the outputting the UI information are performed in response to a request to output the UI information received from the host device.

20. The method of claim 18, wherein when communication is established between the portable storage device and the host device, the portable storage device transmits device information to the host device, enabling the host device to recognize the portable storage device and execute an application corresponding to the portable storage device.
